(19) United States
(12) Patent Application Publication
(10) Pub. No.: US 2026/0057800 A1
(43) Pub. Date: Feb. 26, 2026

(54) DRIVING SIMULATION APPLICATION USING A 360-DEGREE IMAGE OF AN ENVIRONMENT SURROUNDING A VEHICLE

(71) Applicant: Microchip Technology Incorporated, Chandler, AZ (US)

(72) Inventor: Valentin Stoia, Bucharest (RO)

(73) Assignee: Microchip Technology Incorporated, Chandler, AZ (US)

(21) Appl. No.: 18/918,451

(22) Filed: Oct. 17, 2024

Related U.S. Application Data
(60) Provisional application No. 63/686,068, filed on Aug. 22, 2024.

(51) Int. Cl. G09B 9/05; G06V 20/56

(52) U.S. Cl. CPC G09B 9/05; G06V 20/56

(57) ABSTRACT

A system, apparatus, and method for a driving simulation application using a 360-degree image of an environment surrounding a vehicle are disclosed. The apparatus may include a camera interface communicatively coupled a camera mounted on a vehicle. The apparatus may also include a communication interface to communicate with a user device. The apparatus may further include a control circuit. The control circuit may be to receive a 360-degree image of an environment surrounding the vehicle from the camera mounted on the vehicle. The control circuit may also be to process the 360-degree image for incorporation into a driving simulation application including a depiction of the vehicle in the 360-degree image. Additionally, the control circuit may be to transmit the driving simulation application to the user device via the communication interface.

### PRIORITY

This application claims priority to U.S. Provisional Patent Application No. 63/686,068 filed Aug. 22, 2024, the contents of which are hereby incorporated in their entirety.

### TECHNICAL FIELD

The present disclosure relates to a driving simulator, and, in particular a driving simulation application using a 360-degree image of an environment surrounding a vehicle.

### BACKGROUND

Learning to drive often involves an individual taking a driving course with an instructor and driving practice under the supervision of a licensed driver. This practice may place the student and instructor in dangerous situations when the student is practicing in a highly trafficked area or an environment with obstacles. Additionally, learning to drive is resource limited due to one student being able to practice driving at a time. While other passengers in the vehicle may observe the student driver to learn driving techniques, observation is not a substitute for first-hand driving experience.

### SUMMARY OF THE INVENTION

Aspects provide systems and methods for a driving simulation application using a 360-degree image of an environment surrounding a vehicle. Examples of the present disclosure may include an apparatus. The apparatus may include a camera interface communicatively coupled a camera mounted on a vehicle. The apparatus may also include a communication interface to communicate with a user device. The apparatus may further include a control circuit. The control circuit may be to receive a 360-degree image of an environment surrounding the vehicle from the camera mounted on the vehicle. The control circuit may also be to process the 360-degree image for incorporation into a driving simulation application including a depiction of the vehicle in the 360-degree image. Additionally, the control circuit may be to transmit the driving simulation application to the user device via the communication interface.

In combination with any of the above examples, the control circuit may also be to recognize an object in the 360-degree image and incorporate the object into the driving simulation application.

In combination with any of the above examples, the control circuit may also be to introduce an augmented reality element into the 360-degree image and incorporate the augmented reality element into the driving simulation application.

In combination with any of the above examples, the apparatus may further include a sensor interface. The control circuit may be to receive a movement of the vehicle from a sensor and adjust the depiction of the vehicle in the driving simulation application based on the movement of the vehicle.

In combination with any of the above examples, the control circuit may also be to store a dynamic property of the vehicle and adjust the depiction of the vehicle based on the dynamic property.

In combination with any of the above examples, the control circuit may also be to transmit the driving simulation application to a second user device via the communication interface and coordinate an interaction with the driving simulation application from the user device and the second user device.

Alone or in combination with any of the above examples, examples of the present disclosure may include a method. The method may include receiving a 360-degree image of an environment surrounding a vehicle from a camera mounted on the vehicle. The method may also include processing the 360-degree image for incorporation into a driving simulation application including a depiction of the vehicle in the 360-degree image. The method may additionally include transmitting the driving simulation application to a user device.

In combination with any of the above examples, the method may include recognizing an object in the 360-degree image and incorporating the object into the driving simulation application.

In combination with any of the above examples, the method may include introducing an augmented reality element into the 360-degree image and incorporating the augmented reality element into the driving simulation application.

In combination with any of the above examples, the method may include receiving a movement of the vehicle from a sensor and adjusting the depiction of the vehicle in the driving simulation application based on the movement of the vehicle.

In combination with any of the above examples, the method may include storing a dynamic property of the vehicle and adjusting the depiction of the vehicle based on the dynamic property.

In combination with any of the above examples, the method may include transmitting the driving simulation application to a second user device and coordinating interaction with the driving simulation application from the user device and the second user device.

Alone or in combination with any of the above examples, examples of the present disclosure may include an apparatus. The apparatus may include a display interface communicatively coupled to a display of a user device. The apparatus may also include a user input interface communicatively coupled to a user input device. The apparatus may include a communication interface to communicate with a vehicle. The apparatus may additionally include a control circuit. The control circuit may be to receive a driving simulation application of the vehicle via the communication interface. The control circuit may also be to transmit the driving simulation application to the display via the display interface. Additionally, the control circuit may be to receive a user input from the user input device via the user input interface, the user input indicating an interaction with the driving simulation application.

In combination with any of the above examples, the control circuit may also be to receive, via the user input interface, a signal indicating a motion of the user input device and convert the motion of the user input device to the input to the driving simulation application.

In combination with any of the above examples, the control circuit may also be to receive, via the user input interface, a signal indicating an input from a handheld controller and convert the input from the handheld controller to the input to the driving simulation application.

In combination with any of the above examples, the control circuit may also be to introduce an augmented reality element into the driving simulation application.

Alone or in combination with any of the above examples, examples of the present disclosure may include a method. The method may include receiving a driving simulation application a vehicle. The method may also include displaying the driving simulation application on the display. The method may further include receiving an input from a user to interact with the driving simulation application.

In combination with any of the above examples, receiving the input from the user to interact with the driving simulation application via a user interface may include detecting a motion of a user device and converting the motion of the user device to the input to the driving simulation application.

In combination with any of the above examples, receiving the input from the user to interact with the driving simulation application via a user interface may include converting the input from a handheld controller to the input to the driving simulation application.

In combination with any of the above examples, the method may include introducing an augmented reality element into the driving simulation application.

### BRIEF DESCRIPTION OF THE DRAWINGS

The figures illustrate examples of systems and methods for a driving simulation application using a 360-degree image of an environment surrounding a vehicle.

FIG. 1 illustrates a block diagram of a vehicle to enable a driving simulation application, according to examples of the present disclosure;

FIG. 2 illustrates a more-detailed block diagram of a user device to enable a driving simulation application, according to examples of the present disclosure;

FIG. 3 illustrates a block diagram of a user device to enable a driving simulation application, according to examples of the present disclosure;

FIG. 4 illustrates a method performed by a vehicle for a driving simulation application using a 360-degree image of an environment surrounding the vehicle, according to examples of the present disclosure;

FIG. 5 illustrates a more detailed method performed by a vehicle for a driving simulation application using a 360-degree image of an environment surrounding the vehicle, according to examples of the present disclosure;

FIG. 6 illustrates a method performed by a user device for a driving simulation application using a 360-degree image of an environment surrounding a vehicle, according to examples of the present disclosure; and

FIG. 7 illustrates a more detailed method performed by a user device for a driving simulation application using a 360-degree image of an environment surrounding a vehicle, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a driving simulation application using a 360-degree image of an environment surrounding a vehicle is provided. The driving simulation application may use a 360-degree camera view of a moving car to emulate a real-time driving experience. The driving simulation application may use image recognition and may display the camera view on a user's smart device (e.g., smartphone or other wearable device). The driving simulation application may provide a real-time driving feel, allowing users to learn how to drive in various contexts, feel like they are part of the driving experience, experiment or practice driving on real roads, and make the passenger experience more fun.

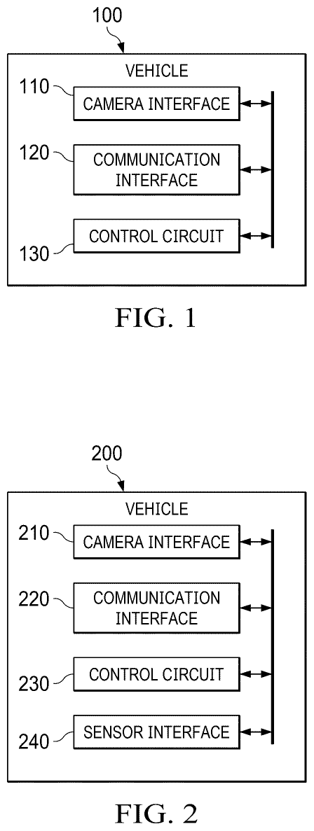

FIG. 1 illustrates a block diagram of a vehicle to enable a driving simulation application, according to examples of the present disclosure. Vehicle 100 may include camera interface 110, communication interface 120, and control circuit 130. Vehicle 100 may be any suitable vehicle in which passengers are located. For example, vehicle 100 may be an automobile, a bus, a train, a boat, or an airplane.

Camera interface 110 may be communicatively coupled to one or more cameras mounted on vehicle 100. Vehicle 100 may be fitted with one or more cameras to provide a 360-degree image about vehicle 100. Specifically, the cameras may be arranged on vehicle 100 such that the cameras capture a 360-degree image of the environment surrounding vehicle 100. The 360-degree image may be transmitted to control circuit 130 via camera interface 110.

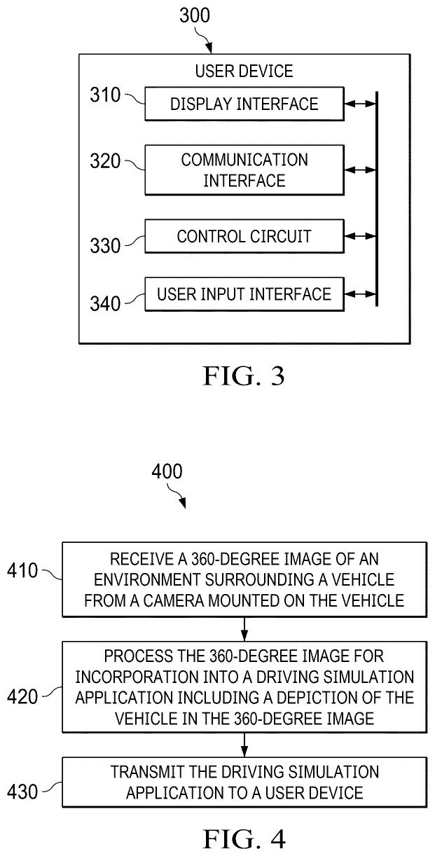

Communication interface 120 may communicate data from control circuit 130 to a user device, such as user device 300 shown in FIG. 3. Specifically, control circuit 130 may transmit the driving simulation application to the user device via communication interface 120. Communication interface 120 may be any suitable type of radio frequency communication interface, including, but not limited to, wired (e.g., Ethernet, universal serial bus (USB), serial (including Universal Asynchronous Receiver/Transmitted (UART)), proprietary cable protocols) and wireless (e.g., Wi-Fi, Bluetooth, Ultra Wideband (UWB), Infrared, MiWi, proprietary radio frequency (RF) protocols) communication interfaces.

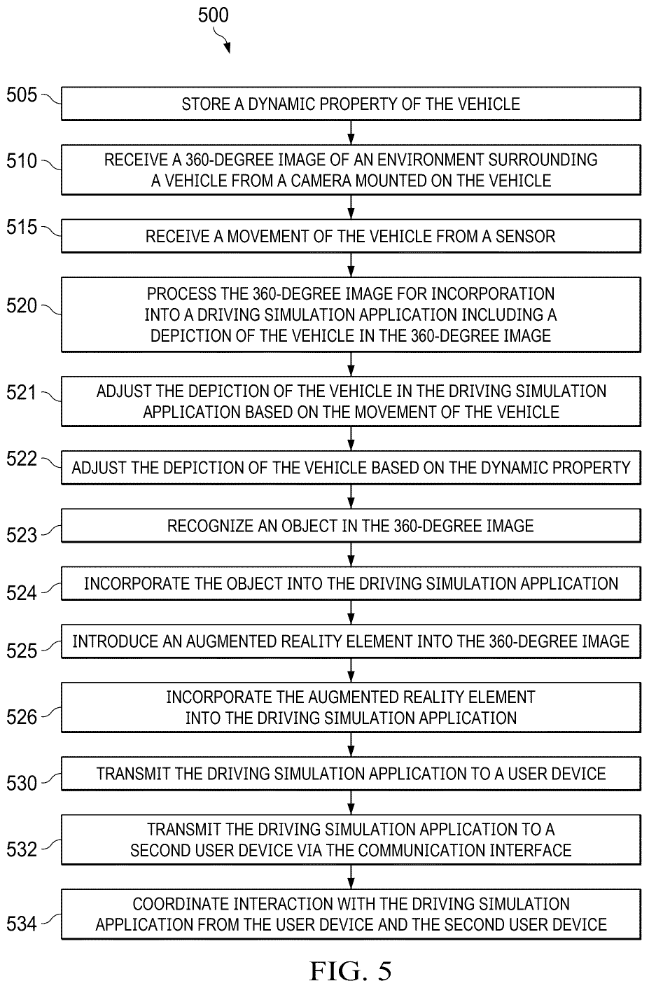

Control circuit 130 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 130 may be communicatively coupled to camera interface 110 and communication interface 120. Control circuit 130 control the operations of the components of vehicle 100, such as, but not limited to, receiving a 360-degree image of an environment surrounding a vehicle from a camera mounted on the vehicle, processing the 360-degree image for incorporation into a driving simulation application including a depiction of the vehicle in the 360-degree image, and transmitting the driving simulation application to a user device. The operations of control circuit 130 are described in further detail with respect to FIGS. 4 and 5.

FIG. 2 illustrates a more-detailed block diagram of a user device to enable a driving simulation application, according to examples of the present disclosure. Vehicle 200 may include camera interface 210, communication interface 220, control circuit 230, and sensor interface 240. Vehicle 200 may be any suitable vehicle in which passengers are located. For example, vehicle 200 may be an automobile, a bus, a train, a boat, or an airplane.

Camera interface 210 may be similar to camera interface 110 shown in FIG. 1 and may be used to transmit a 360-degree image to control circuit 130 from one or more cameras mounted on vehicle 200.

Communication interface 220 may be similar to communication interface 120 shown in FIG. 1 and may communicate data, such as a driving simulation application, from control circuit 230 to a user device.

Control circuit 230 may be similar to control circuit 130 shown in FIG. 1 and may be used to control the operations of the components of vehicle 200, such as, but not limited to, receiving a 360-degree image of an environment surrounding a vehicle from a camera mounted on the vehicle, processing the 360-degree image for incorporation into a driving simulation application including a depiction of the vehicle in the 360-degree image, and transmitting the driving simulation application to a user device. Control circuit 230 may be communicatively coupled to camera interface 210, communication interface 220, and sensor interface 240. The operations of control circuit 230 are described in further detail with respect to FIGS. 4 and 5.

Sensor interface 240 may be communicatively coupled to one or more sensors on vehicle 200. The sensors may capture movement or environmental input (e.g., speed, global positioning system (GPS) location, accelerometers) and communicate data indicative of the movement or environmental input to control circuit 230 via sensor interface 240.

FIG. 3 illustrates a block diagram of a user device to enable a driving simulation application, according to examples of the present disclosure. User device 300 may include display interface 310, communication interface 320, control circuit 330, and user input interface 340. User device 300 may be any suitable device used by a person to interact with the driving simulation application, including, but not limited to, a smartphone, tablet computer, laptop computer, smart wearable, smart glasses, smart watch, virtual reality headset, or any combination thereof.

Display interface 310 may be communicatively coupled to a display on user device 300. The display may present the driving simulation application to a user to enable the user to interact with the driving simulation application. Control circuit 330 may transmit the driving simulation application to the display via display interface 310.

Communication interface 320 may communicate data from control circuit 330 to a vehicle, such as vehicle 100 or vehicle 200 shown in FIGS. 1 and 2, respectively. Specifically, a control circuit in the vehicle may transmit the driving simulation application to user device 300 via communication interface 320. Communication interface 320 may be any suitable type of radio frequency communication interface, including, but not limited to, wired (e.g., Ethernet, USB) and wireless (e.g., Wi-Fi, Bluetooth) communication interfaces.

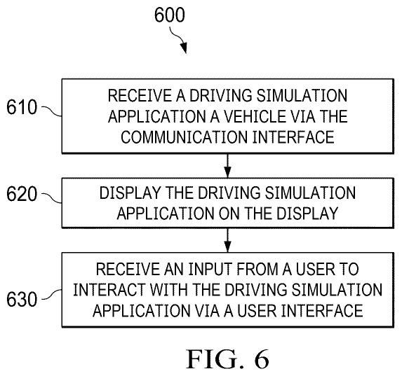

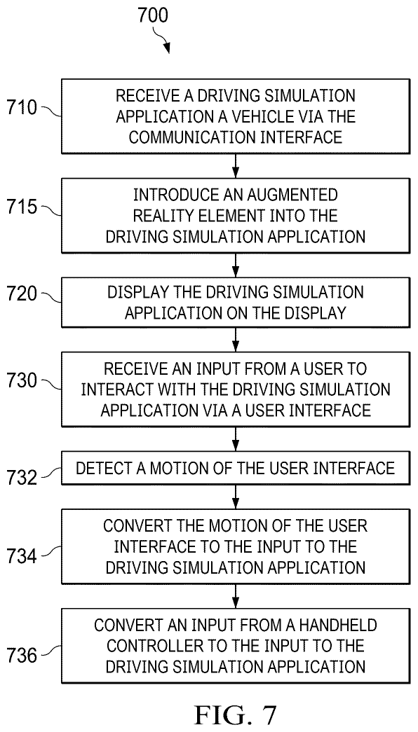

Control circuit 330 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 330 may be communicatively coupled to display interface 310, communication interface 320, and user input interface 340. Control circuit 330 control the operations of the components of user device 300, such as, but not limited to, receiving a driving simulation application a vehicle via the communication interface, displaying the driving simulation application on the display, and receiving an input from a user to interact with the driving simulation application via a user interface. The operations of control circuit 330 are described in further detail with respect to FIGS. 6 and 7.

User input interface 340 may be communicatively coupled with a user input device that allows the user to interact with the driving simulation application. The user input device may be any suitable interface to enable user interaction with the driving simulation application, such as on-screen buttons, microphones to receive voice commands, accelerometers or other sensors to detect changes in position of user device 300 (e.g., the tilt of user device 300). In some examples, the user interface may be separate from user device 300, such as a handheld controller that communicates with user device 300. The user input device may allow the user to interact with the driving simulation application as if the user was interacting with the vehicle steering wheel. For example, an accelerometer may detect the tilt of user device 300 when the user moves user device 300 as if moving a vehicle steering wheel. Signals indicative of the user's interaction with the user input device may be communicated to control circuit 330 via user input interface 340.

FIG. 4 illustrates a method performed by a vehicle for a driving simulation application using a 360-degree image of an environment surrounding the vehicle, according to examples of the present disclosure. Method 400 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 400, such as control circuit 130 or control circuit 230, shown in FIGS. 1 and 2, respectively. Although examples have been described above, other variations and examples may be made from this disclosure without departing from the spirit and scope of these disclosed examples.

Method 400 may begin at block 410 where the control circuit may receive a 360-degree image of an environment surrounding a vehicle from a camera mounted on the vehicle. The camera may be fitted on the vehicle to capture a 360-degree image of the environment surrounding the vehicle. In some examples, the 360-degree image may be provided by a plurality of cameras. A given camera of the plurality of cameras may capture a segment of the 360-degree image and the control circuit may combine images from the plurality of cameras to create the 360-degree image.

At block 420, the control circuit may process the 360-degree image for incorporation into a driving simulation application including a depiction of the vehicle in the 360-degree image. For example, the control circuit may generate and add new data to the 360-degree image to create three-dimensional virtual scenery of the environment. As another example, the control circuit may add a depiction of the vehicle driving through the three-dimensional representation of the 360-degree image.

The driving simulation application may include a buffer to allow the user to drive slower than the vehicle is being driven. The buffer may be limited such that the amount slower the user may drive is based on the length of the buffer. If the passenger reaches the end of the buffer, the driving simulation application may accelerate the simulated vehicle in the driving simulation application or jump the simulated vehicle in time. The passengers may view the car in which they are in while interacting with the driving simulation application. Passengers may be able to drive faster than the vehicle up to the reach of the vehicle's live camera feed. If the passengers reach the limit of the live camera feed, the driving simulation application may limit simulated vehicle's speed.

At block 430, the control circuit may transmit the driving simulation application to a user device via a communication interface. The communication interface may be any suitable type of radio frequency communication interface, including, but not limited to, wired (e.g., Ethernet, USB) and wireless (e.g., Wi-Fi, Bluetooth) communication interfaces. A user may interact with the driving simulation application using the user device, such as by operating the depiction of the vehicle within the 360-degree image as displayed in the driving simulation application.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

FIG. 5 illustrates a more detailed method performed by a vehicle for a driving simulation application using a 360-degree image of an environment surrounding the vehicle, according to examples of the present disclosure. Method 500 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 500, such as control circuit 130 or control circuit 230, shown in FIGS. 1 and 2, respectively. Although examples have been described above, other variations and examples may be made from this disclosure without departing from the spirit and scope of these disclosed examples.

Method 500 may begin at block 505, where the control circuit may store a dynamic property of a vehicle. For example, the control circuit may store a physical capability of the vehicle (e.g., acceleration, braking capability, cornering capability) representing how the vehicle may perform while in operation.

At block 510, the control circuit may receive a 360-degree image of an environment surrounding the vehicle from a camera mounted on the vehicle. The camera may be fitted on the vehicle to capture a 360-degree image of the environment surrounding the vehicle. In some examples, the 360-degree image may be provided by a plurality of cameras. A given camera of the plurality of cameras may capture a segment of the 360-degree image and the control circuit may combine images from the plurality of cameras to create the 360-degree image.

At block 515, the control circuit may receive a movement of the vehicle from a sensor. For example, the control circuit may receive movement and environment input from sensors on the vehicle (e.g., speed, GPS location, accelerometers).

At block 520, the control circuit may process the 360-degree image for incorporation into a driving simulation application including a depiction of the vehicle in the 360-degree image. For example, the control circuit may generate and add new data to the 360-degree image to create three-dimensional virtual scenery of the environment. As another example, the control circuit may add a depiction of the vehicle driving through the three-dimensional representation of the 360-degree image.

At block 521, the control circuit may adjust the depiction of the vehicle in the driving simulation application based on the movement of the vehicle. For example, the control circuit may use the movement data from the sensor (received at block 515) and adjust the depiction of the vehicle such that the depiction of the vehicle has the same movement in the driving simulation application as the movement received from the sensor. For example, the depiction of the vehicle may have the same or similar speed as the speed received from the sensor.

At block 522, the control circuit may adjust the depiction of the vehicle based on the dynamic property (stored at block 505). For example, the control circuit may adjust the depiction of the vehicle such that the depiction of the vehicle has the same dynamic properties (e.g., acceleration, braking capability, cornering capability) as the vehicle itself.

At block 523, the control circuit may recognize an object in the 360-degree image. For example, the control circuit may recognize an object (e.g., a stationary object or a moving object like other vehicles, animals, or people) in the 360-degree image. The image recognition may recognize the object in real-time while the vehicle is moving.

At block 524, the control circuit may incorporate the object into the driving simulation application. For example, at block 523, the control circuit may recognize another vehicle in the 360-image and, at block 524, the control circuit may include the other vehicle in the driving simulation application such that the user of the driving simulation application may avoid the other vehicle while simulating driving the depiction of the vehicle in the driving simulation application. Additionally, the control circuit may recognize scenery in the 360-image using time-of-flight technology for depth sensing.

At block 525, the control circuit may introduce an augmented reality element into the 360-degree image. For example, the control circuit may introduce fake visual elements or surrounding object behavior. As another example, the control circuit may add virtual objects that may relate to the scenery recognized at block 524. In some examples, the augmented reality element introduced into the 360-degree image may be based on a user's profile, the settings of the driving simulation application, or any combination thereof. For example, the control circuit may introduce bouncing balls into the driving simulation application that a user avoids while driving the vehicle in the driving simulation application.

At block 526, the control circuit may incorporate the augmented reality element into the driving simulation application. By incorporating the augmented reality element into the driving simulation application, the control circuit may simulate various driving experiences, such as a crash.

At block 530, the control circuit may transmit the driving simulation application to a user device via a communication interface. The communication interface may be any suitable type of radio frequency communication interface, including, but not limited to, wired (e.g., Ethernet, USB) and wireless (e.g., Wi-Fi, Bluetooth) communication interfaces. A user may interact with the driving simulation application using the user device, such as by operating the depiction of the vehicle within the 360-degree image as displayed in the driving simulation application.

At block 532, the control circuit may transmit the driving simulation application to a second user device via the communication interface. In some examples, there may be more than one passenger in the vehicle and multiple passengers may wish to interact with the driving simulation application. The control circuit may transmit the driving simulation to the second user device in a similar manner as done in block 530.

At block 534, the control circuit may coordinate interaction with the driving simulation application from the user device and the second user device. For example, the control circuit may act as a gaming server and allow the user device and the second user device to participate in a two-person driving simulation. Like in multiplayer personal computer games, a given user may influence the driving simulation application's virtual environment and may impact the experience of the other users of the driving simulation application. The control circuit may account for the user inputs from the first user device and the second user device based on the physics of the vehicle, user profiles, or any combination thereof. As an example of a user profile, a given user may be under 18 years of age and may experience different scenery (e.g., with potential censorship) compared to the scenery presented to another user who is over 18 years of age. The different experiences may be presented even though all users are interacting in the same driving simulation application.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

FIG. 6 illustrates a method performed by a user device for a driving simulation application using a 360-degree image of an environment surrounding a vehicle, according to examples of the present disclosure. Method 600 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 600, such as control circuit 330 shown in FIG. 3. Although examples have been described above, other variations and examples may be made from this disclosure without departing from the spirit and scope of these disclosed examples.

Method 600 may begin at block 610 where the control circuit may receive a driving simulation application of a vehicle via the communication interface. For example, the device may connect to the vehicle using an in-vehicle network (e.g., Wi-Fi). The driving simulation application may be transmitted from a vehicle after a control circuit of the vehicle receives a 360-degree image of an environment surrounding the vehicle and processes the 360-degree image for incorporation into the driving simulation application (e.g., blocks 410 and 420 of method 400 shown in FIG. 4).

At block 620, the control circuit may display the driving simulation application on the display. The control circuit may transmit the driving simulation application to the display using a display interface, such as display interface 310 shown in FIG. 3.

At block 630, the control circuit may receive a user input from the user input device via the user input interface. A passenger may begin interacting with the driving simulation application at the beginning (or during) a trip by connecting a user device to the vehicle. The user may interact with the driving simulation application using a user input device that is communicatively coupled with a user input interface (e.g., user input interface 340 shown in FIG. 3).

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

FIG. 7 illustrates a more detailed method performed by a user device for a driving simulation application using a 360-degree image of an environment surrounding a vehicle, according to examples of the present disclosure. Method 700 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 700, such as control circuit 330 shown in FIG. 3. Although examples have been described above, other variations and examples may be made from this disclosure without departing from the spirit and scope of these disclosed examples.

Method 700 may begin at block 710 where the control circuit may receive a driving simulation application of a vehicle via the communication interface. For example, the device may connect to the vehicle using an in-vehicle network (e.g., Wi-Fi). The driving simulation application may be transmitted from a vehicle after a control circuit of the vehicle receives a 360-degree image of an environment surrounding the vehicle and processes the 360-degree image for incorporation into the driving simulation application (e.g., blocks 410 and 420 of method 400 shown in FIG. 4).

At block 715, the control circuit may introduce an augmented reality element into the driving simulation application. By introducing the augmented reality element into the driving simulation application, the control circuit may simulate various driving experiences, such as a crash, that are not occurring in the real driving experience of the vehicle.

At block 720, the control circuit may display the driving simulation application on the display. The control circuit may transmit the driving simulation application to the display using a display interface, such as display interface 310 shown in FIG. 3.

At block 730, the control circuit may receive a user input from the user input device via the user input interface. A passenger may begin interacting with the driving simulation application at the beginning (or during) a trip by connecting a user device to the vehicle. The user input may indicate a user's interaction with the driving simulation application. The user may interact with the driving simulation application using a user input device that is communicatively coupled with a user input interface (e.g., user input interface 340 shown in FIG. 3).

At block 732, the control circuit may detect a motion of the user device. For example, the user device may include accelerometers or other sensors to detect changes in position of the user device (e.g., the tilt of the user device). The user device may allow the user to interact with the driving simulation application as if the user was interacting with the vehicle steering wheel. For example, an accelerometer may detect the tilt of the user device when the user moves the user device as if moving a vehicle steering wheel.

At block 734, the control circuit may convert the motion of the user interface to the input to the driving simulation application. For example, the control circuit may use the motion detected at block 732 to determine whether the user is turning the vehicle in the driving simulation application left or right based on the tilt of the user device. The control circuit may then communicate the input to the vehicle for incorporation in the driving simulation application.

At block 736, the control circuit may convert an input from a handheld controller to the input to the driving simulation application. In some examples, the user device may include a separate controller, such as a handheld controller that communicates with the user device. The control circuit may detect motion of the handheld controller in a similar manner as motion of the user device (e.g., block 732).

Although FIG. 7 discloses a particular number of operations related to method 700, method 700 may be executed with greater or fewer operations than those depicted in FIG. 7. In addition, although FIG. 7 discloses a certain order of operations to be taken with respect to method 700, the operations comprising method 700 may be completed in any suitable order.

While FIGS. 6 and 7 describe the control circuit on the user device receiving the driving simulation application from the vehicle, in some examples, the hardware and software resources may be offloaded from the user device (e.g., user device 300 shown in FIG. 3) to the vehicle (e.g., vehicle 100 or vehicle 200 shown in FIGS. 1 and 2, respectively), and vice versa. Specifically, the user device may include software for processing three-dimensional imaging of the driving experience such that the user device receives the 360-degree image from the vehicle and processes the image into the driving simulation application in a similar manner as described with respect to blocks 410 and 420 of method 400 shown in FIG. 4. For example, the scenery for the driving simulation application may be fully provided by software, hardware, or a combination thereof on the vehicle. The driving simulation application may be run on the hardware on the vehicle and the passengers may play the driving simulation application by accessing the driving simulation application through an interface, for example an internet browser. By offloading the driving simulation application to the vehicle, the user device may have less hardware and energy requirements. Additionally, the driving simulation application may allow multiple passengers in the vehicle to experience the same events in the driving simulation application experience. As another example, the driving simulation application scenery, including artificial reality, may be calculated by the user device. In this example, the vehicle may provide the 360-degree camera feed and other processing to provide the driving simulation application may be provided by the user device.

The driving simulation application described above may offer multiple objectives to a user interacting with the driving simulation application. For example, a user may earn points by obeying driving rules, for safe driving, for saving car energy, or for performing tricks (e.g., drifting). The driving simulation application may be used in automotive, aeronautic, consumer, and entertainment industries.

The driving simulation application may provide a realistic learning experience for passengers of the vehicle. Additionally, the driving simulation application may reuse existing components of the vehicle and may not impose additional requirements for the device used by the user to interact with the driving simulation application. Further, the driving simulation application may provide an engaging and fun experience, addressing that long vehicle trips may be boring or non-engaging for passengers.

Although examples have been described above, other variations and examples may be made from this disclosure without departing from the spirit and scope of these disclosed examples.

1. An apparatus, comprising:
a camera interface communicatively coupled a camera mounted on a vehicle;
a communication interface to communicate with a user device; and
a control circuit to:
receive a 360-degree image of an environment surrounding the vehicle from the camera mounted on the vehicle;
process the 360-degree image for incorporation into a driving simulation application including a depiction of the vehicle in the 360-degree image; and
transmit the driving simulation application to the user device via the communication interface.

2. The apparatus of claim 1, wherein the control circuit is to:
recognize an object in the 360-degree image; and
incorporate the object into the driving simulation application.

3. The apparatus of claim 1, wherein the control circuit is to:
introduce an augmented reality element into the 360-degree image; and
incorporate the augmented reality element into the driving simulation application.

4. The apparatus of claim 1, comprising:
a sensor interface; and
wherein the control circuit is to:
receive a movement of the vehicle from a sensor; and
adjust the depiction of the vehicle in the driving simulation application based on the movement of the vehicle.

5. The apparatus of claim 1, wherein the control circuit is to:
store a dynamic property of the vehicle; and
adjust the depiction of the vehicle based on the dynamic property.

6. The apparatus of claim 1, wherein the control circuit is to:
transmit the driving simulation application to a second user device via the communication interface; and
coordinate an interaction with the driving simulation application from the user device and the second user device.

7. A method, comprising:
receiving a 360-degree image of an environment surrounding a vehicle from a camera mounted on the vehicle;
processing the 360-degree image for incorporation into a driving simulation application including a depiction of the vehicle in the 360-degree image; and
transmitting the driving simulation application to a user device.

8. The method of claim 7, comprising:
recognizing an object in the 360-degree image; and
incorporating the object into the driving simulation application.

9. The method of claim 7, comprising:
introducing an augmented reality element into the 360-degree image; and
incorporating the augmented reality element into the driving simulation application.

10. The method of claim 7, comprising:
receiving a movement of the vehicle from a sensor; and
adjusting the depiction of the vehicle in the driving simulation application based on the movement of the vehicle.

11. The method of claim 7, comprising:
storing a dynamic property of the vehicle; and
adjusting the depiction of the vehicle based on the dynamic property.

12. The method of claim 7, comprising:
transmitting the driving simulation application to a second user device; and
coordinating interaction with the driving simulation application from the user device and the second user device.

13. An apparatus, comprising:
a display interface communicatively coupled to a display of a user device;
a user input interface communicatively coupled to a user input device;
a communication interface to communicate with a vehicle; and
a control circuit to:
receive a driving simulation application of the vehicle via the communication interface;
transmit the driving simulation application to the display via the display interface; and
receive a user input from the user input device via the user input interface, the user input indicating an interaction with the driving simulation application.

14. The apparatus of claim 13, wherein the control circuit is to:
receive, via the user input interface, a signal indicating a motion of the user input device; and
convert the motion of the user input device to the input to the driving simulation application.

15. The apparatus of claim 13, wherein the control circuit is to:
receive, via the user input interface, a signal indicating an input from a handheld controller; and
convert the input from the handheld controller to the input to the driving simulation application.

16. The apparatus of claim 13, wherein the control circuit is to introduce an augmented reality element into the driving simulation application.

17. A method, comprising:
receiving a driving simulation application a vehicle;
displaying the driving simulation application on the display; and
receiving an input from a user to interact with the driving simulation application.

18. The method of claim 17, wherein receiving the input from the user to interact with the driving simulation application via a user interface includes:
detecting a motion of a user device; and
converting the motion of the user device to the input to the driving simulation application.

19. The method of claim 17, wherein receiving the input from the user to interact with the driving simulation application via a user interface includes converting the input from a handheld controller to the input to the driving simulation application.

20. The method of claim 17, comprising introducing an augmented reality element into the driving simulation application.
